(19) United States
(12) Patent Application Publication
(10) Pub. No.: US 2008/0001004 A1
(43) Pub. Date: Jan. 3, 2008

(54) Crop sprayer axle assembly

(75) Inventor: Chad A. Ringer, Trafalgar, IN (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: Equipment Technologies, Inc., Mooresville, IN (US)

(21) Appl. No.: 11/476,291

(22) Filed: Jun. 28, 2006

(51) Int. Cl. A01G 25/09; B05B 9/00; B05B 9/06

(52) U.S. Cl. 239/146; 239/147; 239/156

(57) ABSTRACT

A crop sprayer axle assembly includes a differential output shaft extending from a differential and coupled to a transfer drive shaft. The transfer drive extends downwardly from the differential output shaft and in a lengthwise direction with respect to the crop sprayer where it is operably connected to a wheel drive shaft.

### FIELD

The present invention relates generally to a crop sprayer, and more particularly to an axle assembly for a crop sprayer.

### BACKGROUND

A crop sprayer is used to distribute chemicals, such as herbicides, pesticides, and fertilizer, over crops in a field during a spraying operation. The chemicals are maintained in a liquid solution and stored in a tank onboard the crop sprayer for use as the crop sprayer transits through a field.

It should be appreciated that it is often necessary to apply spray applications during the final stages of the growth cycle of the crops in the field. Thus, because some crops grow to a substantial height, it is necessary for a crop sprayer to be configurable such that the frame or other components associated with the sprayer may be positioned at a sufficient enough height above the field surface so as to clear the tops of various types of crops as the sprayer is advanced through the field.

As noted above, however, the chemicals that are distributed are in a liquid form that is stored in a tank. Thus, as the frame and other components are raised to accommodate the height of the crops, the location of the center of gravity for the sprayer is likewise raised. The increased height thus increases the instability of the crop sprayer, particularly in view of the potential for sloshing of the liquid chemicals in the tank as rough terrain is traversed.

Accordingly, the various components of crop sprayers are configured so as to minimize any reduction in clearance between the frame of the crop sprayer and the field so as to minimize the overall height of the vehicle. To this end, drop down gear boxes have been developed to transfer rotational movement from the differential of a crop sprayer to the drive shafts of the wheels of the crop sprayer. Drop down gear boxes are configured to transfer rotation from a differential output shaft at a given height through one or more gears to a wheel drive shaft at a different height. Thus, the differential output shaft of a crop sprayer may be located within a hollow frame member that extends between two wheels of the crop sprayer at a height significantly above the height of the center of the wheels. Gear boxes may then be located just inboard of the wheels so as to transfer the rotation of the differential output shaft down to the wheel drive shaft in the center of the wheel.

While gear boxes are very effective at minimizing the reduction of clearance between the frame of a crop sprayer and the field, gear boxes increase the cost of the crop sprayer. Additionally, the complexity of the gear boxes increases the potential for a breakdown of the crop sprayer leading to delays in applying the chemicals to the crops.

Moreover, the openings in the frame support member that are required for connection of the drive shaft within the hollow frame member to other components in the drive train weaken the frame member, necessitating heavier and more expensive frame members. Similarly, offsetting the axle from directly above the rotational axis of the wheels requires increased bulk in the axle to provide the requisite support and splitting the axle into two separate components, one forward of the axis of rotation and the other rearward of the axis of rotation, increases manufacturing complexity and weight of the crop sprayer.

What is needed therefore is an apparatus for reducing the complexity of the components needed to transfer rotational movement from a differential output shaft to a wheel drive shaft while avoiding excessive reduction in the clearance between the axle assembly and the ground. It is further desired that the apparatus be capable of incorporation into a crop sprayer without penetrating an axle or splitting the axle.

### SUMMARY

In accordance with one embodiment of the present invention, there is provided a crop sprayer axle assembly including a differential with a differential output shaft extending therefrom. A transfer drive shaft is operably connected to the differential output shaft. The transfer drive shaft extends downwardly from the differential output shaft and in a lengthwise direction with respect to the crop sprayer and is operably connected to a wheel drive shaft.

In accordance with another embodiment of the present invention, there is provided a crop sprayer axle assembly with an axle extending in a first plane. A wheel drive shaft is positioned such that the axis of rotation of the wheel drive shaft is also in the first plane and a transfer drive shaft is operatively coupled to the wheel drive shaft and extends in a skewed direction with respect to the first plane. A differential is operatively connected to the transfer drive shaft. Additionally, the first plane is substantially normal to a horizontal axis of a crop sprayer and the differential is horizontally spaced apart from the first plane.

In accordance with a further embodiment, a crop sprayer axle assembly includes a wheel drive shaft having an axis of rotation and an axle extending along a line parallel to the axis of rotation and horizontally aligned with the axis of rotation. A differential is located adjacent to the axle and a transfer drive shaft extends horizontally between the differential and the wheel drive shaft and is operable to transfer rotational movement from the differential to the wheel drive shaft.

### DESCRIPTION OF THE DRAWINGS

FIG. 1 shows a front perspective view of a crop sprayer incorporating principles of the present invention;

FIG. 2 shows a rear plan view of the rear axle assembly of the crop sprayer of FIG. 1 from the rear differential to the wheel drive axle with various other components not shown for clarity of description;

FIG. 3 shows a schematic view of the drive train assembly from the engine to the rear differential output shaft and the crop sprayer control assembly of the crop sprayer of FIG. 1;

FIG. 4 shows an enlarged partial perspective view of the rear axle assembly of the crop sprayer of FIG. 1 from the rear differential to the wheel drive axle including a portion of the axle with various other components not shown for clarity of description; and

FIG. 5 shows a schematic side view of the relative locations of a rear wheel, the rear axle and the rear differential of the crop sprayer of FIG. 1.

### DESCRIPTION

While the invention is susceptible to various modifications and alternative forms, specific embodiments thereof have been shown by way of example in the drawings and will herein be described in detail. It should be understood, however, that there is no intent to limit the invention to the particular forms disclosed, but on the contrary, the intention is to cover all modifications, equivalents, and alternatives falling within the spirit and scope of the invention as defined by the appended claims.

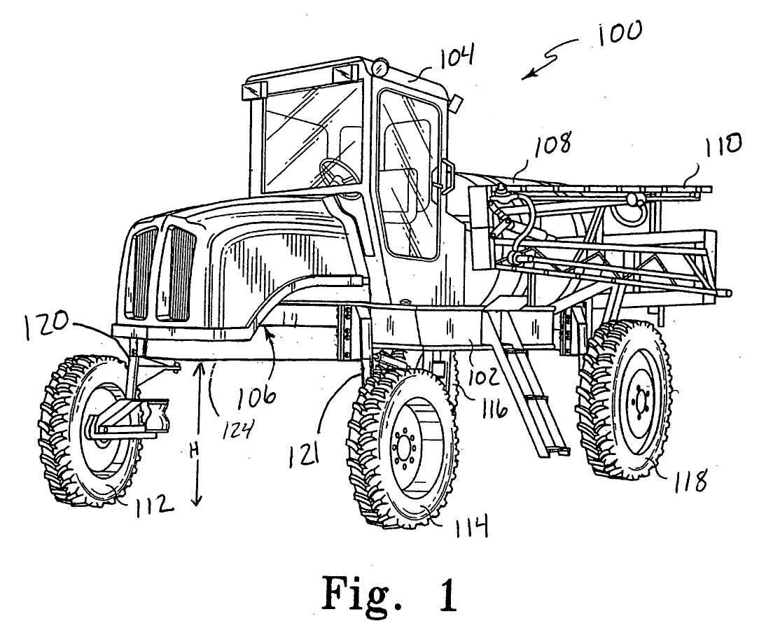

Referring now to FIG. 1, there is shown a work machine such as a crop sprayer 100. The crop sprayer 100 includes a chassis 102 that provides a structure for mounting numerous components associated with the crop sprayer 100 thereon. For example, the crop sprayer 100 includes a cab 104 which is mounted on the chassis 102. The cab 104 houses a seat for an operator and a number of controls which may be manipulated by the operator in order to control operation of the crop sprayer 100 during performance of a work function such as an agricultural spraying function.

The crop sprayer 100 also includes an engine 106 which is mounted on a forward portion of the chassis 102 in front of the cab 104. The engine 106 may be any type of engine such as a diesel engine commercially available from Cummins Engine Co. Inc., of Columbus, Ind. or Deere & Company of Moline Ill. Moreover, while the embodiment of FIG. 1 shows the engine 106 mounted at the front end of the crop sprayer 100, in alternative embodiments, the engine may be mounted elsewhere on the crop sprayer such as at the rear of the crop sprayer.

The crop sprayer 100 further includes a storage tank 108 which stores liquid chemicals such as herbicides, pesticides, and fertilizers that are to be sprayed on a field. The storage tank 108 is mounted on the chassis 102 at a location which is aft of the cab 104. The crop sprayer 100 also includes a boom assembly 110 which may be deployed and is operable to distribute the chemicals in the storage tank 108 over a wide area in a field. In particular, the liquid chemicals are distributed by a number of nozzles (not shown) which are spaced along the boom assembly 110 through which the liquid chemicals are sprayed as the crop sprayer 100 is propelled along the rows associated with the field. In alternative embodiments, the storage tank and boom assembly may be located at different locations on the crop sprayer such as at the front end of the crop sprayer.

The chassis 102 is supported by two front wheels 112 and 114 and two rear wheels 116 and 118. The chassis 102 is supported by the two front wheels 112 and 114 through support brackets 120 and 121, respectively. The brackets 120 and 121 are fixedly attached to an axle 124 which in turn is fixedly attached to the chassis 102. The axle 124 is located directly above the axes of rotation of the wheels 112 and 114 when the wheels 112 and 114 are steered to a straight forward direction. As shown in FIG. 1, the clearance for the front end of the crop sprayer 100 between the wheels 112 and 114 is defined by the height “H” of the axle 124 above the ground.

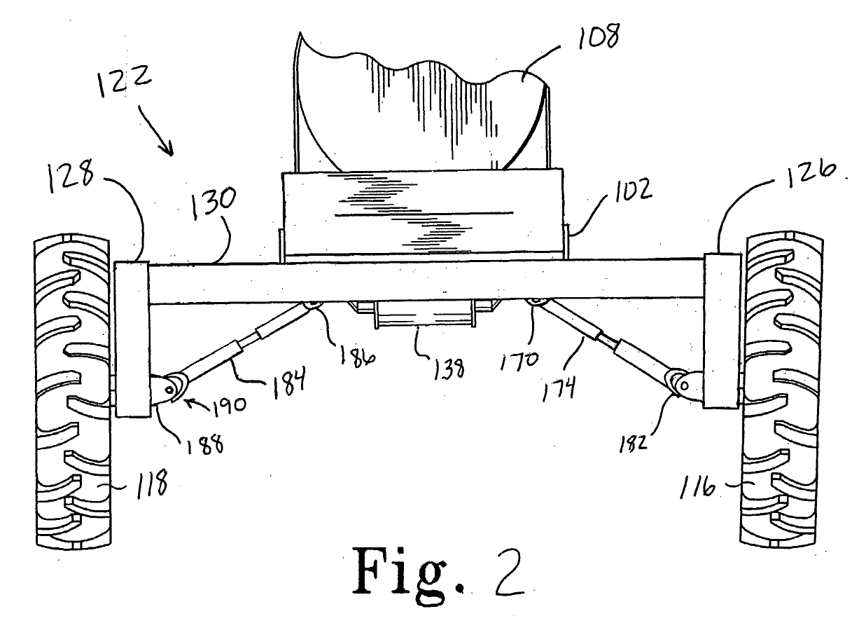

As shown in FIG. 2, the rear of the chassis 102 is supported by the two rear wheels 116 and 118 through an axle assembly 122 that includes the support brackets 126 and 128. The brackets 126 and 128 are fixedly attached to an axle 130 which in turn is fixedly attached to the chassis 102. The axle 130 is located directly above the axes of rotation of the wheels 116 and 118 in a plane normal to the central lengthwise axis of the crop sprayer 100.

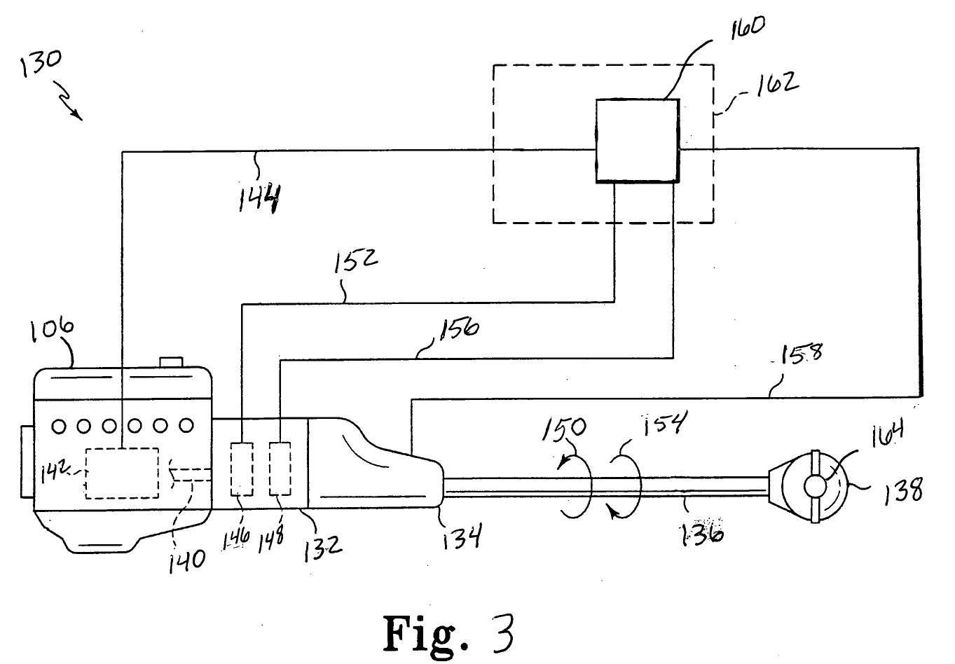

Propulsion for the crop sprayer 100 is provided through a drive train assembly 130 shown in FIG. 3. The drive train assembly 130 includes the engine 106, a clutch assembly 132, a transmission 134, a main drive shaft 136 and a rear differential 138. The clutch assembly 132, the transmission 134, the main drive shaft 136 and the rear differential 138 in this embodiment are commercially available as a matched set from International Transmissions LTD of Wrexham, United Kingdom as transmission and axle package 475/45200.

The engine 106 generates rotational mechanical energy which is transferred to the clutch assembly 132 by a crankshaft 140 of the engine 106. The engine 106 includes a throttle 142. The throttle 142 is operable to control rotational speed of the crankshaft 140 of the engine 106. In particular, the throttle 142 controls the amount of air that is advanced into a combustion chamber (not shown) of the engine 106. As the amount of air advanced into the combustion chamber is increased, the flow of fuel injected into the combustion chamber is similarly increased. By increasing the amount of fuel and air combusted in the combustion chamber of the engine 106, the rotational speed of the crankshaft 140 of the engine 106 is increased. A signal is sent over a signal line 144 to control the position the throttle 142 during operation of the engine 106 so as to control the rotational speed of the crankshaft 140.

The clutch assembly 132 is positioned between the engine 106 and the main drive shaft 136. The clutch assembly 132 includes a torque converter which has a forward clutch 146 and a reverse clutch 148. The forward clutch 146 is operable to selectively couple and decouple the crankshaft 140 of the engine 106 to the drive shaft 136. In particular, when the forward clutch 146 couples the crankshaft 140 to the drive shaft 136, the drive shaft 136 is caused to rotate in a clockwise rotational direction, as indicated by the arrow 150. Whereas, when the forward clutch 146 decouples the crankshaft 140 from the drive shaft 136, the drive shaft 136 is not caused to rotate in the direction of the arrow 150.

The forward clutch 146 is actuated so as to couple the crankshaft 140 to the drive shaft 136 in response to an electric signal being received via a signal line 152. In particular, when an “on” signal is received by the forward clutch 146 via the signal line 152, the forward clutch 146 couples the crankshaft 140 to the drive shaft 136 so as to rotate the drive shaft 136 in the clockwise rotational direction. When an “off” signal is received by the forward clutch 146 via the signal line 152, the forward clutch 146 decouples the crankshaft 140 from the drive shaft 136.

Similarly, the reverse clutch 148 is operable to selectively couple and decouple the crankshaft 140 of the engine 106 to the drive shaft 136. In particular, when the reverse clutch 148 couples the crankshaft 140 to the drive shaft 136, the drive shaft 136 is caused to rotate in a counterclockwise rotational direction, as indicated by the arrow 154. When the reverse clutch 148 decouples the crankshaft 140 from the drive shaft 136, the drive shaft 136 is not caused to rotate in the counterclockwise rotational direction indicated by the arrow 154.

The reverse clutch 148 is actuated so as to couple the crankshaft 140 to the drive shaft 136 in response to an electric signal being received via a signal line 156. In particular, when an “on” signal is received by the reverse clutch 148 via the signal line 156, the reverse clutch 148 couples the crankshaft 140 to the drive shaft 136 so as to rotate the drive shaft 136 in the counterclockwise rotational direction. When an “off” signal is received by the reverse clutch 148 via the signal line 156, the reverse clutch 148 decouples the crankshaft 140 from the drive shaft 136.

The transmission 134 is interposed between the clutch assembly 132 and the drive shaft 136. The transmission 134 in this embodiment is a four speed transmission which is operative to provide four separate gear ratios between the crankshaft 140 and the drive shaft 136. The transmission 134 allows the operator to selectively change the gear ratio between the clutch assembly 132 and the drive shaft 136. In particular, when an “up-shift” signal is received by the transmission 134 via the signal line 158, the transmission 134 decouples the previously selected gear from the forward clutch 146 and couples the gear with the next highest gear ratio to the forward clutch 146 so as to rotate the drive shaft 136 at a higher rotational speed but with less torque. When a “down-shift” signal is received by the transmission 134 via the signal line 158, the transmission 134 decouples the previously selected gear from the forward clutch 146 and couples the gear with the next lowest gear ratio to the forward clutch 146 so as to rotate the drive shaft 136 at a lower rotational speed but with more torque. Thus, the change of gear ratios allows the engine 106 to provide torque to the main drive shaft 136 for a variety of operating conditions. In particular, a gear ratio may be selected that provides high torque at low crankshaft speeds whereas a different gear ratio may be selected that provides low torque at high crankshaft speeds.

The signal lines 144, 152, 156 and 158 extend between a microprocessor 160 and the respective component. The microprocessor 160 is part of a crop sprayer control assembly 162 which is located in the cab 104.

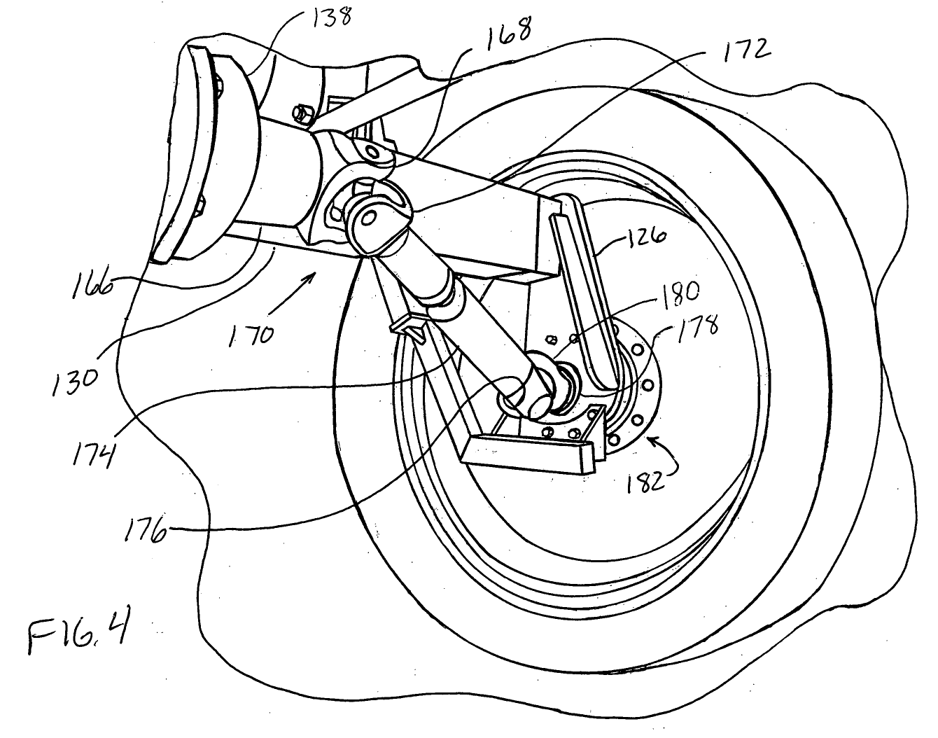

The rear differential 138, which is part of the axle assembly 122 as well as a part of the drive train assembly 130, receives the rotational movement of the drive shaft 136. The rear differential 138 splits the power from the drive shaft 136 between other components of the axle assembly 122 which are operably connected to the rear wheels 116 or 118 in order to propel the crop sprayer 100 in the forward direction and the reverse direction. More specifically, the rear differential 138, which in this embodiment is located just forward of and at about the same height as the axle 130, splits the power from the main drive shaft 136 between a left differential output shaft 164 (FIG. 3) and a right differential output shaft 166 which is shown in FIG. 4.

Continuing with FIG. 4, the outward end of the right differential output shaft 166 is configured as a portion 168 of a universal joint 170. The other end of the universal joint 170 is the end portion 172 of a transfer drive shaft 174. The transfer drive shaft 174 extends to the rear and downwardly to an end portion 176 that is underneath the axle 130. A wheel drive shaft 178 extends through the support bracket 126 to an end portion 180 which is coupled to the end portion 176 to form a universal joint 182.

Similarly, as shown in FIG. 2, the outward end of the left differential output shaft 164 is coupled to a transfer drive shaft 184 through a universal joint 186. The transfer drive shaft 184 extends to the rear and downwardly with respect to the crop sprayer 100 to a point underneath the axle 130. The transfer drive shaft 184 is coupled to a wheel drive shaft 188, which extends through the support bracket 128, through a universal joint 190.

Accordingly, as the main drive shaft 136 rotates, the rear differential 138 is forced to rotate. The rear differential 138 splits the power from the main drive shaft 136 and causes the left differential output shaft 164 and the right differential output shaft 166 to rotate. The rotation is mechanically passed through the universal joints 186 and 170 to the transfer shafts 184 and 174 and on to the universal joints 190 and 182, respectively. The rotation of the universal joints 190 and 182 forces the wheel drive shafts 188 and 178 to rotate, thereby rotating the rear wheel 118 and the rear wheel 116, respectively.

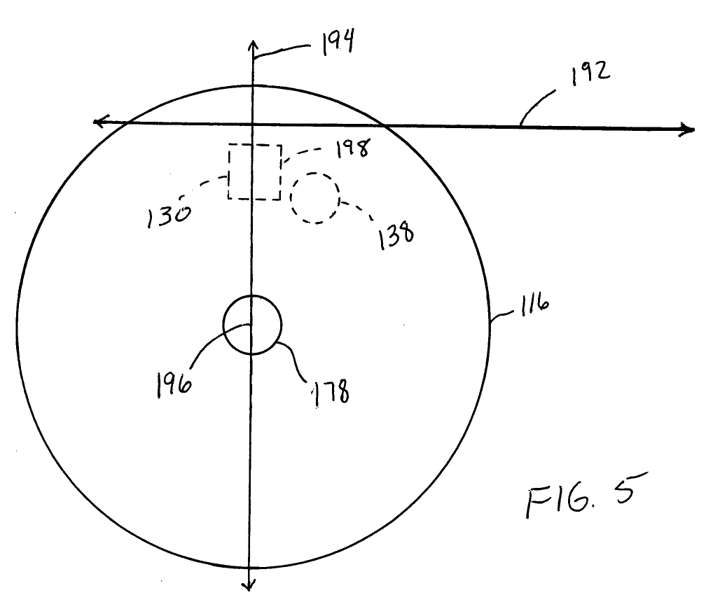

The relative position of the foregoing components is shown more clearly in FIG. 5 which is a schematic diagram of various components of the axle assembly 122 with respect to the rear wheel 116. A horizontal axis 192 extends along the length of the crop sprayer 100 and is intersected by a vertical axis 194 which extends through the center of rotation of the wheel drive shaft 178 at point 196. The axle 130 is located directly above the point 196. The axle 130 and the point 196 thus lay on a plane that is normal to the horizontal axis 192. In this embodiment, the rear differential 138 is located adjacent to the inner side 198 which is the forward side of the axle 130. Accordingly, the transfer drive shaft 174 must extend along the lengthwise axis 192 of the crop sprayer 100 in the rearward direction and in a downward direction with respect to the axis 194 to transfer rotational movement from the differential 138 to the wheel drive shaft 178.

Alternatively, a rear differential may be located behind the rear axle. In such an embodiment, clearance at the rear of the crop sprayer is maximized by directing the main drive shaft of the crop sprayer above the rear axle, although the main drive shaft may be directed beneath the axle. In either of these embodiments, the transfer drive shaft associated with a rear differential located behind a rear axle will extend in a forward direction along a lengthwise axis as well as in a downward direction.

Returning to FIG. 2, the configuration of the axle assembly 122 results in a varying clearance between the axle assembly 122 and the ground. At the center of the axel 130, the rear differential is only slightly lower than the axle 130. Thus, the clearance is substantially the same as the clearance at the front axle 124. The clearance between the ground and the axle assembly 122 is reduced as the distance outwardly from the center of the axle 130 increases, however, because of the transfer drive shafts 174 and 184. The reduction in clearance is most significant at the universal joints 182 and 190. Typically, the universal joints 182 and 190 which are adjacent to the wheels 116 and 118 will be located in an open area between the rows of crops as are the wheels 116 and 118. Thus, a portion of the transfer drive shafts 174 and 184 having a height above ground greater than the universal joints 182 and 190 will be presented to crops. Additionally, because the transfer drive shafts 174 and 184 are angled upwardly toward the center of the axle 130, any crops that are contacted will be pushed inwardly to a point of higher clearance. This reduces the potential for damaging crops that are contacted.

Thus, in the above described embodiment, rotational movement of a drive shaft is transferred to a wheel drive shaft without penetrating an axle and without the use of a gear box. Moreover, the reduction in clearance resulting form the disclosed configuration is minimal and the configuration does not necessitate a split axle.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

What is claimed is:

1. A crop sprayer axle assembly comprising:
a differential;
a differential output shaft extending from the differential;
a transfer drive shaft operably connected to the differential output shaft and extending downwardly from the differential output shaft and extending in a lengthwise direction with respect to the crop sprayer; and
a wheel drive shaft operably connected to the transfer drive shaft.

2. The crop sprayer axle assembly of claim 1, further comprising:
an axle located adjacent to the differential such that the differential output shaft extends along a side portion of the axle and the transfer drive shaft extends to a location below the axle.

3. The crop sprayer axle assembly of claim 2, wherein the differential is located closer to the center of the crop sprayer along a lengthwise axis of the crop sprayer than the axle.

4. The crop sprayer axle assembly of claim 2, wherein the axle is a rear axle of a crop sprayer.

5. The crop sprayer axle assembly of claim 1, wherein:
the differential output shaft and the transfer drive shaft are coupled through a first universal joint; and
the transfer drive shaft and the wheel drive shaft are coupled through a second universal joint.

6. A crop sprayer axle assembly comprising:
an axle extending in a first plane;
a wheel drive shaft positioned such that the axis of rotation of the wheel drive shaft is in the first plane;
a transfer drive shaft operatively coupled to the wheel drive shaft and extending in a skewed direction with respect to the first plane; and
a differential operatively connected to the transfer drive shaft, wherein the first plane is substantially normal to a horizontal axis of a crop sprayer and the differential is horizontally spaced apart from the first plane.

7. The crop sprayer axle assembly of claim 6, wherein the differential is horizontally spaced apart from the first plane in a direction toward the center of the crop sprayer.

8. The crop sprayer axle assembly of claim 6, further comprising:
a differential output shaft extending from the differential and operatively coupled to the transfer drive shaft, the differential output shaft having an axis of rotation parallel to the first plane.

9. The crop sprayer assembly of claim 8, wherein the differential output shaft is operatively coupled to the transfer drive shaft through a first universal joint and the transfer drive shaft is operatively coupled to the wheel drive shaft through a second universal joint.

10. A crop sprayer axle assembly comprising:
a wheel drive shaft having an axis of rotation;
an axle extending along a line parallel to the axis of rotation and horizontally aligned with the axis of rotation;
a differential located adjacent to the axle; and
a transfer drive shaft extending horizontally between the differential and the wheel drive shaft and operable to transfer rotational movement from the differential to the wheel drive shaft.

11. The crop sprayer axle assembly of claim 10, wherein the differential is located closer to the center of the crop sprayer along a lengthwise axis of the crop sprayer than the axle.

12. The crop sprayer axle assembly of claim 11, wherein the transfer drive shaft is coupled to the differential through a first universal joint and is coupled to the wheel drive shaft through a second universal joint.

13. The crop sprayer axle assembly of claim 12, wherein the axle is the rear axle of the crop sprayer.

14. The crop sprayer axle assembly of claim 12, wherein the axle is the front axle of the crop sprayer.
